(19) United States
(12) Patent Application Publication
(10) Pub. No.: US 2003/0114781 A1
(43) Pub. Date: Jun. 19, 2003

(54) Hand-held massage tool

(76) Inventors: Randy Beaty, Littleton, CO (US); Sharon Hilst, Littleton, CO (US)

Correspondence Address: EMERY L. TRACY, ATTORNEY AT LAW, P.O. Box 1518, Boulder, CO, 80306, US

(21) Appl. No.: 10/354,338

(22) Filed: Jan. 30, 2003

Related U.S. Application Data
(63) Continuation of application No. 09/988,238, filed on Nov. 19, 2001.
(60) Provisional application No. 60/253,177, filed on Nov. 27, 2000.

(51) Int. Cl. A61H 7/00

(52) U.S. Cl. 601/135

(57) ABSTRACT

A hand-held massage tool for promoting circulation to the tissue and muscles of a patient is provided. The hand-held massage tool comprises a substantially conical first end and a dome-like second end substantially opposite the first end. A concave elongated center portion is positioned between the first end and the second end with the center portion having a longitudinal axis and being shaped for grasping by a single hand for beneficial manipulation of the first end and the second end against a patient using slight adjustments while maintaining contact with the patient. A method for massaging a patient is also provided.

The present application is a continuation and claims the benefit of pending U.S. patent application Ser. No. 09/988,238, filed on Nov. 19, 2001, entitled “Hand-Held Massage Tool” which is a continuation and claims the benefit of pending U.S. Provisional Patent Application Serial No. 60/253,177, filed on Nov. 27, 2000, entitled “Hand-Held Massage Tool”.

### BACKGROUND OF THE INVENTION

1. Field of the Invention

This invention relates generally to a hand-held massage tool and, more particularly, it relates to a hand-held massage tool, which allows the massage therapist to work more deeply while inhibiting occupational injury to the massage therapist.

2. Description of the Prior Art

The massaging of various parts of the body is an old and well-known art. It is well known that massaging relaxes the muscles, improves circulation, and generally improves the feeling of well being of an individual or patient. It is also believed that massaging has major health benefits. In fact, massage therapy is a popular way to treat a variety of ailments including sore or tired muscles, headaches, minor injuries, stress, poor blood circulation, chronic pain syndromes, and decreases injury rehabilitation time.

Perhaps the oldest and most well known technique of massaging is by the use of the hands and fingers of the massage therapist. While hand and finger massaging is believed to be most beneficial, the hand or finger massage is exhausting for the massage therapist and cannot be self applied without additional stress to the hands. Continuous massaging stresses the fingers, the thumbs, the hands, and the wrist. For this reason, certain implements have been developed in an effort to provide somewhat equivalent benefit to hand or finger massage and also to enable self-massaging. Unfortunately, one problem with the conventional massage tools is that they were not comfortable for the massage therapist to hold and manipulate.

Accordingly, there exists a need for a hand-held massage tool which promotes circulation to the tissue of a patient. Additionally, a need exists for a hand-held massage tool which has an ergonomic shape for inhibiting occupational injury to the massage therapist. Furthermore, there exists a need for a hand-held massage tool which imitates the hands, thumbs, and fingers of the massage therapist to provide a beneficial massage to a patient.

### SUMMARY

The present invention is a hand-held massage tool for promoting circulation to the tissue and muscles of a patient. The hand-held massage tool comprises a substantially conical first end and a dome-like second end substantially opposite the first end. A concave elongated center portion is positioned between the first end and the second end with the center portion having a longitudinal axis and being shaped for grasping by a single hand for beneficial manipulation of the first end and the second end against a patient using slight adjustments while maintaining contact with the patient.

Additionally, the present invention is a method for massaging a patient by a massage therapist. The method comprises providing a massage tool having a center portion, a substantially conical first end, and a dome-like second end, concaving the center portion of the massage tool, grasping the center portion, positioning either the first end or second end of the massage tool against a patient, and applying force to the massage tool to separate and compress muscle tissue, release muscle tension, and dissipate trigger points, and clean and flush the tissue of unwanted toxins.

The present invention further includes a device for massaging a person's body. The device comprises a handle having a dome-like first end and a dome-like second end, the handle having a longitudinal axis. A substantially cylindrical first projection extends from the first end along the longitudinal axis of the handle, the first projection having a diameter less than the diameter of the handle. A substantially wedge-shaped second projection extends from the second end substantially perpendicular to the longitudinal axis of the handle, the second projection tapering to a point.

### BRIEF DESCRIPTION OF THE DRAWINGS

FIG. 1 is a perspective view of a hand-held massage tool, constructed in accordance with the present invention, which promotes circulation to the tissue of a patient while inhibiting occupational injury to the massage therapist; and

FIG. 2 is a perspective view of another embodiment of a hand-held massage tool, constructed in accordance with the present invention, which promotes circulation to the tissue of a patient while inhibiting occupational injury to the massage therapist.

### DETAILED DESCRIPTION OF THE PREFERRED EMBODIMENTS

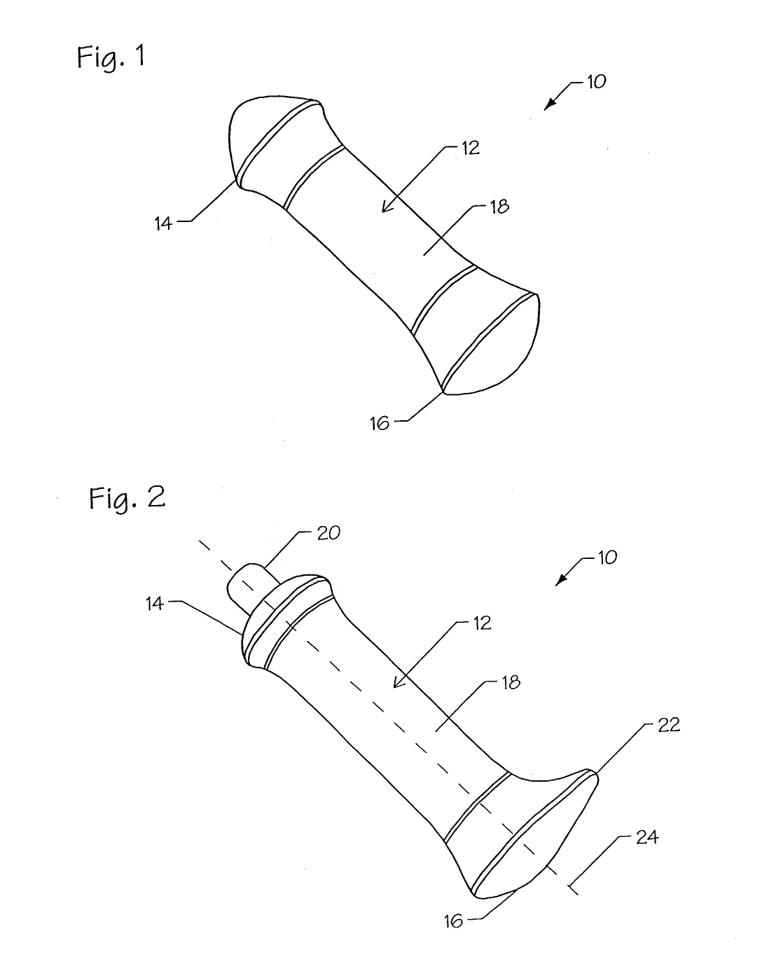

As illustrated in FIG. 1, the present invention is a hand-held massage tool, indicated generally at 10, for promoting circulation to the tissue and muscles of a patient (not shown) while inhibiting occupational and potential injury to the massage therapist without compromising the comfort of the patient. The massage tool 10 separates, compresses, and releases muscle tension and dissipates trigger points for better blood flow and release of pain and stiffness in an area of the patient's body. Additionally, the massage tool 10 flushes tissue effectively helping to stretch and elongate the muscle.

The massage tool 10 of the present invention includes an elongated member 12 having a first end 14, a second end 16 substantially opposite the first end 14, and a center portion 18 between the first end 14 and the second end 16. In a first embodiment, as illustrated in FIG. 1, the first end 14 and the second end 16 of the elongated member 12 are substantially rounded. In a second embodiment, as illustrated in FIGS. 2 and 3, the first end 14 is substantially rounded and further includes a first end protrusion 20 extending in a direction substantially parallel to a longitudinal axis 24 of the elongated member 12 and the second end is substantially rounded and includes a second end protrusion 22 extending in a direction substantially perpendicular to the longitudinal axis 24 of the elongated member 12. Actual construction and benefits of the various embodiments of the tool member 12 of the present invention will be described in further detail below.

The center portion 18 of the elongated member 12 is preferably sized for allowing a hand 26 of the massage therapist to comfortably grasp the elongated member 12 while inhibiting injury of the hand 26 the massage therapist during use of the massage tool 10. The size and shape of the center portion 18 of the elongated member 12 of the massage tool 10 actually allows a massage therapist to lightly hold the massage tool 10 thereby preventing stress and/or cramping of the massage therapist's hand 26 while performing vigorous massage techniques, in various hand-held positions, such as separating muscle fibers and muscle tissue flushing. In fact, the massage tool 10 of the present invention allows the massage therapist to continue working even with painful or injured hands, thumbs, and/or fingers without any further injury or pain.

As discussed briefly above, as illustrated in FIG. 1, in the first embodiment of the massage tool 10, the first end 14 and the second end 16 of the elongated member 12 are substantially rounded. The actual rounding of the first end 14 and the second end 16 can be identical to each other, or the first end 14 can have a sharper rounding than the second end 16, or the first end 14 can have a shallower rounding than the second end 16. Regardless, the first end 14 and the second end 16 of the elongated member 12 of the first embodiment allows the massage therapist to use either the first end 14 or the second end 16, or both, to move from cross-fiber work to deep tissue flushing and compression strokes and into trigger point therapy without losing contact with the patient's body.

As illustrated in FIG. 2, in the second embodiment of the massage tool 10, the first end 14 of the elongated member 12 has the first end protrusion 20 extending in a generally outward direction from the first end 14 and the second end 16 of the elongated member 12 has the second end protrusion 22 extending in a generally outward direction from the second end 16. With the first end protrusion 20 and the second end protrusion 22, the massage tool 10 of the present invention further improves the abilities, versatility, and effectiveness of the massage therapist. The first end protrusion 20 and the second end protrusion 22 gives the massage therapist the ability to affect muscles of the patient that were previously hard to reach such as the suboccipitals, the multifidus, and in between the transverse processes of the spine. The second end protrusion 22 of the massage tool 10 further allows scooping the underlying muscle fibers.

The massage tool 10 of the present invention is preferably constructed from a ceramic material with the first end 14 and the second end 16, including the first end protrusion 20 and the second end protrusion 22, of the elongated member 12 being glazed. The glazed first end 14 and the glazed second end 16 of the elongated member 12 allows the massage tool 10 to glide smoothly on either the patient's clothing or lubricated skin. It should be noted that while the massage tool 10 has been described as being constructed from a ceramic material, it is within the scope of the present invention to construct the massage tool 10 from other types of material including, but not limited to metal, wood, plastic, stone, crystal, etc.

The massage tool 10 is available in a wide variety of shapes and sizes. For instance, the center portion 18 of the elongated member 12 can have a variety of sizes for both small and big hands. The actual length of the elongated member 12 can be varied to allow the first end protrusion 20 and the second end protrusion 22 to extend beyond the massage therapist's hand to increase the massage therapist's ability to achieve proper tissue depth and pressure while working on patients, including muscular athletes and clients. The leverage action of the massage tool 10 increases the massage therapist's ability to maneuver deeper into the tissue of the patient.

The massage tool 10 of the present invention can be used anywhere on the body of the patient. The massage tool 10 actually flushes the tissues of the patient's body comparative to the massage therapist's hands or elbow. In fact, experimental clinical tests have revealed that a patient can not tell the difference between the massage therapist'hands and the massage tool 10. The massage therapist, on the other hand, can still feel the texture of the patient's muscle tissue through the massage tool 10.

The massage tool 10 of the present invention can be used hot, cold, or at body temperature. When the massage tool is used hot, it relaxes and softens muscle tissue which promotes better circulation and pain relief. When the massage tool 10 is used cold, it inhibits local inflammation. When inflammation is decreased, circulation is correspondingly increased.

The massage tool 10 is an excellent choice for reflexology and seated massage without adding discomfort to the patient. The massage therapist can literally work twice as deep into the tissue with half the effort of using the hands alone. Furthermore, the massage tool 10 is portable and can be carried anywhere. A carrying case can be used to protect the massage tool 10 from any accidental damage.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements, which are disclosed herein.

What is claimed is:

1. A hand-held massage tool for promoting circulation to the tissue and muscles of a patient, the hand-held massage tool comprising:
a substantially conical first end;
a dome-like second end substantially opposite the first end; and
a concave elongated center portion between the first end and the second end, the center portion having a longitudinal axis, the center portion being shaped for grasping by a single hand for beneficial manipulation of the first end and the second end against a patient using slight adjustments while maintaining contact with the patient.

2. The hand-held massage tool of claim 1 and further comprising:
a single first end protrusion extending from the first end in a direction substantially parallel to the longitudinal axis; and
a single second end protrusion extending from the second end in a direction substantially perpendicular to the longitudinal axis;
wherein the first end protrusion and the second end protrusion provides separation, compression, and release of patient muscle tension and dissipates trigger points for better blood flow and release of pain and stiffness in the patient.

3. The hand-held massage tool of claim 2 wherein the first end protrusion is substantially cylindrical and has a diameter less than the least diameter of the center portion.

4. The hand-held massage tool of claim 2 wherein the second end protrusion has a wedge-shaped configuration allowing scooping of underlying muscle fibers.

5. The hand-held massage tool of claim 1 wherein the center portion is sized and shaped for allowing comfortable grasping of the center portion.

6. The hand-held massage tool of claim 1 wherein the rounding of the first end is substantially equivalent to the rounding of the second end.

7. The hand-held massage tool of claim 1 wherein the rounding of the first end is shallower than the rounding of the second end.

8. The hand-held massage tool of claim 1 wherein the massage tool is constructed from a ceramic material.

9. The hand-held massage tool of claim 1 wherein the first end and the second end are glazed, the center portion being free from glazing.

10. A method for massaging a patient by a massage therapist, the method comprising:
providing a massage tool having a center portion, a substantially conical first end, and a dome-like second end;
concaving the center portion of the massage tool;
grasping the center portion;
positioning either the first end or second end of the massage tool against a patient; and
applying force to the massage tool to separate and compress muscle tissue, release muscle tension, and dissipate trigger points, and clean and flush the tissue of unwanted toxins.

11. The method of claim 10 wherein the center portion is substantially concave having a least diameter at the narrowest point, and further comprising:
extending a single, substantially cylindrical first end protrusion from the first end in a direction substantially parallel to the longitudinal axis, the first end protrusion having a diameter less than the least diameter of the center portion

12. The method of claim 10 and further comprising:
extending a single, wedge-shaped second end protrusion extending from the second end in a direction substantially perpendicular to the longitudinal axis; and
scooping the underlying muscle fibers with the wedge-shaped second end protrusion.

13. The method of claim 10 wherein the center portion is sized and shaped for allowing comfortable grasping of the center portion.

14. The method of claim 10 wherein the rounding of the first end is substantially equivalent to the rounding of the second end.

15. The method of claim 10 wherein the rounding of the first end is shallower than the rounding of the second end.

16. The method of claim 10 and further comprising:
constructing the massage tool from a ceramic material.

17. The method of claim 10 and further comprising:
glazing the rounded first end; and
glazing the rounded second end;
wherein the center portion is free from glazing.

18. A device for massaging a person's body, the device comprising:
a handle having a dome-like first end and a dome-like second end, the handle having a longitudinal axis;
a substantially cylindrical first projection extending from the first end along the longitudinal axis of the handle, the first projection having a diameter less than the diameter of the handle; and
a substantially wedge-shaped second projection extending from the second end substantially perpendicular to the longitudinal axis of the handle, the second projection tapering to a point.

19. The device of claim 18 wherein the handle has a substantially concave configuration.

20. The device of claim 18 wherein the first end and the second end are glazed.
